(19) United States
(12) Patent Application Publication
(10) Pub. No.: US 2024/0386370 A1
(43) Pub. Date: Nov. 21, 2024

(54) CUSTOMER RETURN MANAGEMENT SYSTEM

(71) Applicant: Target Brands, Inc., Minneapolis, MN (US)

(72) Inventors: Te Yang, Minneapolis, MN (US); Gregory Lisso, Minneapolis, MN (US); Karla Kilian, Minneapolis, MN (US); Ashfak Jafri, Minneapolis, MN (US); Tyler Park, Minneapolis, MN (US); Sean Griffin, Minneapolis, MN (US); David Ogunewe, Minneapolis, MN (US); Patrick McRaith, Minneapolis, MN (US); Nicole Loehr, Minneapolis, MN (US); Divya Ds, Minneapolis, MN (US); Xinbo Wang, Minneapolis, MN (US); Majid Jahani, Minneapolis, MN (US); Kayla Bosak, Minneapolis, MN (US)

(21) Appl. No.: 18/199,202

(22) Filed: May 18, 2023

(51) Int. Cl. G06Q 10/0837; G06Q 30/06

(52) U.S. Cl. CPC G06Q 10/0837; G06Q 30/06

(57) ABSTRACT

A customer return management system operates to categorize reverse items for resale, such as returned items or overstock inventory, and deliver the categorized items through a variety of different reverse supply chains in a way to increase a net recovery rate. The system employs a two-step process for sorting the reverse items into different reverse supply channels. In a first step, the items can be scanned and divided into two categories based on their value, such as high value items and low value items. The low value items can be quickly liquidated as a bulk. The high value items can be categorized into a number of different sorts, which are taken to different resale channels.

### TECHNICAL FIELD

This document describes devices, systems, and methods related to sorting reverse items into different categories for different resale channels.

### BACKGROUND

Reverse or salvage items, such as returned products, floor damages, overstocks, etc., are typically sold in large pallets, which are useful for discount stores or other large entities that have demand for products in bulk. These discount stores or large entities are low yielding channels, liquidating unsorted or un-manifested pallets of items in bulk at contracted rates. However, the rate of return through these channels steadily declines, compared to higher yielding sale channels, such as direct-to-consumer (D2C) or business-to-business (B2B) channels, that are tailored for targeted, high value items. Typical reverse logistics schemes are not suitable for categorizing reverse items in a granular manner and determining various resale channels suitable for different categories of reverse items in a way that significantly increases a net income from the resale.

### SUMMARY

The document generally relates to categorizing reverse items for resale, such as returned items or overstock inventory, and delivering the categorized items through a variety of different reverse supply chains in a way to increase a net recovery rate. The disclosed technology involves a two-step process for sorting the reverse items into different reverse supply channels. First, when the reverse items are initially identified at, for example, a retail store (e.g., when customers return the items), the items can be scanned and divided into two categories based on their value. The two categories can include low value items and high value items. The value of each item can depend on a variety of input factors, for example, a value of the item in a relevant market (e.g., a retail value or a value in a secondary market) and an expense that will be incurred for resale of the item. A threshold that splits the low and high value items can be determined such that a large number of items (e.g., 70% of the reverse items) can be categorized as low value items during this first sortation step and a small number of items can be categorized as high value items. In other words, the threshold can be determined based on a predetermined value calculated from the cost and the expense of each item in a relevant resale market. A bulk of items categorized as low value can be transported to various third party resale networks (e.g., deep discount retailers) that are designed for quick liquidation at a relatively low cost. Therefore, the items of low value can be liquidated quickly to reduce overhead costs.

On the other hand, the items categorized as high value can be shipped to a dedicated return center where a second sortation step can occur. At the return center, some high value items, such as highest value items or items having values that satisfy a threshold level of value, can first be manually tested and graded for condition (e.g., Mint, Like New, Very Good, Good, Refurbished, etc.). The conditioned items can then be scanned and assorted in a granular manner. In some implementations, items that may go through a category-level sort may bypass testing and grading to save expenses and resources. Moreover, the high value items that fail testing and grading may then be directed to a category-level sort rather than being sold as an individual item. For example, the items can be categorized into a large number (e.g., 90 or more) of different sorts, which are potentially taken to different resale channels. The second sortation can be based on various factors, such as the cost, the expense, and the condition of each item. For example, the items categorized into the highest value sort can be sold individually (not as a bundle or a whole sale) in suitable markets (e.g., eBay or other online or offline markets). Further, the items can be categorized into multiple subcategory sorts, and each of the subcategory sorts can be sold at different channels (e.g., sold at contracted rates (certain % of original retail cost) or open at auction). Only a small portion (e.g., 7%) of the reverse items may be categorized as the highest value sort, and a particular portion (e.g., 20-25%) of the reversed items may be categorized as different subcategory sorts. Alternatively or in addition, a reverse item can be categorized into the high value sort when it retains a predetermined ratio (e.g., 50-70%) of its original retail value. The subcategories in the second sortation can be determined to reflect various attributes of the items and appropriately group those into different sorts. By way of example, the subcategories can include sporting goods, men's pants, men's shirts, etc. The subcategories can be adjusted over time in a way to increase profit of the resale.

The sortation techniques described herein can provide a granular approach in segmenting reverse items into a number of narrow category and sub-category level sorts that meet a wide range of needs from buyers. By segmenting items based on the sub-category level (e.g., Furniture, Bath, Bedding, etc.), buyers are able to purchase specific item types they are targeting. The techniques described herein can create a large number (e.g., 96) of sorts to access D2C and High Yield B2B channels and introduce new D2C capabilities related to item grading (New, A-grade, B-grade), unit-level put-away, and order fulfillment after the point of sale for the high value salvage items (e.g., 27.5% of salvage volume) within the central return center. As described above, the remaining low value items (e.g., 72.5% of salvage volume) can be sold via un-sorted and un-manifested bulk liquidation that flow directly to vendors from the stores, thereby bypassing the central return center. The disclosed techniques may also provide solutions that achieve the sorting and manifesting necessary to execute this granular sortation strategy. This high sortation solution can enable leveraging all three available selling channels within the secondary market to increase gross income of the retailer.

Sometimes, the techniques described herein include a low sortation capability that separates high value salvage items (e.g., 27.5% of salvage volume) and low value salvage items (e.g., 72.5% of salvage volume) within stores. This initial sortation can drive incremental benefit by enabling a targeted selling strategy based on resale value of a given item. Low sortation in the two-step sortation process can generate an improved yield by sorting salvage items into one or more (e.g., 13) categories prior to selling on high yield resale channels (e.g., B2B channels). High value salvage items can therefore be sent to a central return center to be sorted for sale on the high yield resale channels, while low value items can be sold via un-sorted and un-manifested bulk liquidation that can flow directly to vendors from the stores (where the reverse items are initially received) bypassing the central return center. As a result, a retailer can leverage two of the three available selling channels within the secondary market to increase gross income.

Similar to the low sortation solution, the techniques described herein can optionally include separating the high value salvage items (e.g., 27.5% of salvage volume) from the low value salvage items (e.g., 72.5% of salvage volume) within stores, with the high value salvage items being directed to the central return center for additional sortation. Introducing more granular sortation steps, each level of sorts within the central return center can enable the sale of salvage directly to consumers for a certain portion of the salvage items (e.g., 7.2% of salvage volume). In addition to selling D2C, additional value can be realized within the B2B channel through greater sub-category level sorts beyond the category level within the central return center for a certain portion of the salvage items (e.g., 20.2% of salvage volume).

Particular embodiments described herein include a method for reselling reverse items through multiple resale channels, the method including: identifying, using a first computing system, a group of reverse items by scanning identifiers provided at the group of reverse items, accessing, using the first computing system, a database storing reverse item data, retrieving, using the first computing system and based on the identifiers of the group of reverse items, first values of the group of reverse items from the database, identifying, using the first computing system and based on the retrieved first values being equal to or less than a threshold value, one or more of the group of reverse items as a first sort of reverse items, identifying, using the first computing system and based on the retrieved first values exceeding the threshold value, one or more of the group of reverse items as a second sort of reverse items, delivering, using a transportation system, the first sort of reverse items to at least one first resale channel, the first resale channel being configured to liquidate the first sort of reverse items as a bulk, and delivering, using the transportation system, the second sort of reverse items to a resale warehouse, where, at the resale warehouse, the second sort of reverse items can be categorized into a group of sub-sorts of reverse items, and a group of second resale channels can be determined for the group of sub-sorts of reverse items, the group of sub-sorts of reverse items being transported into the group of second resale channels, respectively.

In some implementations, the method can optionally include one or more of the following features. For example, the first values of the group of reverse items can be determined based on resale costs and resale expenses of the group of reverse items. The threshold value can be determined such that a majority of the group of reverse items can be categorized as the first sort of reverse items. The majority of the group of reverse items can be at least 70% of the group of reverse items. The threshold value can be a predetermined monetary value.

The method can also include identifying, using a second computing system associated with the resale warehouse, the second sort of reverse items by scanning identifiers provided at the second sort of reverse items, accessing, using the second computing system, a second database storing reverse item data and available resale channels, retrieving, using the second computing system and based on the identifiers of the second sort of reverse items, second values of the second sort of reverse items from the second database, determining, using the second computing system and based on the retrieved second values, the second sort of reverse items as the group of sub-sorts of reverse items, determining, using the second computing system and based on the available resale channels, the group of second resale channels for the group of sub-sorts of reverse items, and delivering, using the transportation system, the group of sub-sorts of reverse items to the group of second resale channels, respectively, in which the group of sub-sorts of reverse items can be resold independently through the group of second resale channels. The second values of the second sort of reverse items can be determined based on resale costs, resale expenses, and conditions of the second sort of reverse items. In some implementations, determining (i) the second sort of reverse items as the group of sub-sorts of reverse items and (ii) the group of second resale channels for the group of sub-sorts of reverse items can include: calculating, using the second computing system and based on the identifiers of the second sort of reverse items, the second values of the second sort of reverse items from the second database with respect to each of at least one of the available resale channels, categorizing, using the second computing system and based on the calculated values, the second sort of reverse items into the group of sub-sorts of reverse items, and determining, using the second computing system and based on the available resale channels, the group of second resale channels for the group of sub-sorts of reverse items, each of the group of second resale channels being determined to provide a profit for a corresponding one of the group of sub-sorts of reverse items, the profit being greater than a profit offered by other available resale channels for the corresponding one of the group of sub-sorts of reverse items. The group of sub-sorts of reverse items may include at least one first sub-sort of reverse items that can be resold as individual items through at least one of the group of second resale channels. The group of sub-sorts of reverse items may include at least one second sub-sort of reverse items, each second sub-sort of reverse items being sold as a whole through at least one of the group of second resale channels.

In some implementations, the method can also include processing, using the first computing system, payment from the first resale channel, the payment being determined at a rate contacted with the first resale channel. The method can include processing, using the second computing system, payment from the at least one of the group of second resale channels, the payment being determined based on a price paid or payable by a buyer at the at least one of the group of second resale channels. In some implementations, the first computing system may include one or more barcode scanners.

One or more embodiments described herein can include a computing system for reselling reverse items through multiple resale channels, the system including: a data processing apparatus and a memory device storing instructions that when executed by the data processing apparatus cause the server to perform operations including: identifying, using a first computing system, a group of reverse items by scanning identifiers provided at the group of reverse items, accessing, using the first computing system, a database storing reverse item data, retrieving, using the first computing system and based on the identifiers of the group of reverse items, first values of the group of reverse items from the database, identifying, using the first computing system and based on the retrieved first values being equal to or less than a threshold value, one or more of the group of reverse items as a first sort of reverse items, identifying, using the first computing system and based on the retrieved first values exceeding the threshold value, one or more of the group of reverse items as a second sort of reverse items, delivering, using a transportation system, the first sort of reverse items to at least one first resale channel, the first resale channel liquidating the first sort of reverse items as a bulk, and delivering, using the transportation system, the second sort of reverse items to a resale warehouse, where, at the resale warehouse, the second sort of reverse items can be categorized into a group of sub-sorts of reverse items, and a group of second resale channels can be determined for the group of sub-sorts of reverse items, the group of sub-sorts of reverse items being transported into the group of second resale channels, respectively.

In some implementations, the computing system can optionally include one or more of the abovementioned features and/or one or more of the following features. For example, the first values of the group of reverse items can be determined based on resale costs and resale expenses of the group of reverse items. The threshold value can be determined such that a majority of the group of reverse items can be categorized as the first sort of reverse items. The threshold value can be a predetermined monetary value. The operations further can include: identifying, using a second computing system associated with the resale warehouse, the second sort of reverse items by scanning identifiers provided at the second sort of reverse items, accessing, using the second computing system, a second database storing reverse item data and available resale channels, retrieving, using the second computing system and based on the identifiers of the second sort of reverse items, second values of the second sort of reverse items from the second database, determining, using the second computing system and based on the retrieved second values, the second sort of reverse items as the group of sub-sorts of reverse items, determining, using the second computing system and based on the available resale channels, the group of second resale channels for the group of sub-sorts of reverse items, and delivering, using the transportation system, the group of sub-sorts of reverse items to the group of second resale channels, respectively, in which the group of sub-sorts of reverse items can be resold independently through the group of second resale channels. In some implementations, determining (i) the second sort of reverse items as the group of sub-sorts of reverse items and (ii) the group of second resale channels for the group of sub-sorts of reverse items may include: calculating, using the second computing system and based on the identifiers of the second sort of reverse items, the second values of the second sort of reverse items from the second database with respect to each of at least one of the available resale channels, categorizing, using the second computing system and based on the calculated values, the second sort of reverse items into the group of sub-sorts of reverse items, and determining, using the second computing system and based on the available resale channels, the group of second resale channels for the group of sub-sorts of reverse items, each of the group of second resale channels being determined to provide a profit for a corresponding one of the group of sub-sorts of reverse items, the profit being greater than a profit offered by other available resale channels for the corresponding one of the group of sub-sorts of reverse items. The group of sub-sorts of reverse items may include at least one first sub-sort of reverse items that are resold as individual items through at least one of the group of second resale channels, and the group of sub-sorts of reverse items may include at least one second sub-sort of reverse items, each second sub-sort of reverse items being sold as a whole through at least one of the group of second resale channels.

The devices, system, and techniques described herein may provide one or more of the following advantages. In particular, some embodiments described herein include a system for sorting reverse items into low value items for bulk salvage and high value items that are again classified into granular categories. The granular categories are adjusted to maximize the maximum recovery profile, and the resale channels for the categories (including D2C and B2B channels) are also adapted accordingly.

Some embodiments described herein include a decision engine that determines aftermarket sales channels for particular reverse items, which increases profits from the resale of the reverse items. Some embodiments of the present disclosure offer techniques for dynamically generating and adjusting the decision engine to increase or maximize a net income from the reverse items flowing through the reverse networks. The decision engine can be dynamically updated and adaptable to process large sets of data to determine how to resell reverse items. The decision engine can also leverage machine learning algorithms and models to accurately determine how to resell reverse items to optimize net income for the retailer.

Some embodiments described herein provide techniques for improving the reverse business to generate additional income by increasing operations capabilities to sort, grade, and manifest end of life (EOL) products for sale in more profitable channels. It has been understood that the income from reverse item resale would be steadily declining over years due to market saturation, market change, and other factors. However, the techniques of the present disclosure offer significant change in operational capabilities to improve sorting, grading, and manifesting capacity over time (e.g., every year), thereby causing the net income from the resale of reverse items to increase over time.

Typically, all or most of the items that enter the reverse network from stores and distribution centers are placed on pallets and delivered to several different salvage vendors. However, it has been difficult to track and identify the items on the pallets. Further, it was typically unknown the pallet prices on which the salvage vendors agreed during bidding processes. With this conventional system, a net rate of return on these reverse items may be low. At a high level, the techniques according to the present disclosure provide a reverse and re-commerce strategy involving separation between low value items and high value items. With this ability, the same salvage vendors can be utilized to take pallets of low value items while the high value items can be separated out and sent to new reverse item nodes (e.g., dedicated warehouses) to process a granular process for sorting, grading, and manifesting. The manifested pallets of high value items can be disposed through high value resale channels (e.g., Business-to-Business (B2B) channels). In addition, some high value items can be individually sold through other suitable resale channels (e.g., Direct-to-Customer (D2C) channels) that can increase or maximize the resale profit. These additional higher touch channels can yield an improved net rate of return.

For increasing the operational capacities within the reverse network, the new reverse item nodes (e.g., dedicated warehouses) can be equipped with the enhanced capabilities offered by the sortation decision/disposition engine according to the present disclosure. The engine can provide a software platform for warehouse management and sortation to assist the operation of the new reverse item nodes. As described herein, the sortation decision engine is configured to receive and analyze sales data and generate recommendations for optimized resale channels for reverse items, which improve or maximize the resale profit.

Furthermore, the disclosed technology can be integrated seamlessly into existing systems to provide specific intelligence to optimize net incomes regarding reverse networks in the retail network. The disclosed technology can provide for automatic assessment of potential retail value with any available resale channel(s) as well as potential value of a reverse item as a raw material or component for reuse or production of new items. Similarly, the disclosed technology provides for seamless integration of new channels both quickly and easily, as those channels are created (e.g., adding a D2C channel, adding a new recycling capability). The disclosed technology can be integrated with regulatory rules to ensure compliance with auto-defect, ESIM, recalls and other unique circumstances. Moreover, the disclosed technology can provide assessments of cost associated with various resale channels, inclusive of transportation, labor, refurbishment-reconditioning, revenue shares, etc. The disclosed technology can also leverage data from final dispositions to continuously improve the rules and intelligence algorithms, rules, and/or models that drive the decision logic described herein. The disclosed technology may also provide reports in real-time and/or near real-time about volume and routing of reverse items as well as one or more metrics that can be used to understand how each reverse item and/or resale channel is performing. This information can be used by relevant stakeholders to optimize net income throughout the reverse network of the retail network. Similarly, relevant stakeholders can generate override rules to manage exceptions in decisions made using the disclosed techniques, such as donating items to support CR even when a higher value disposition may be available.

As yet another example, the disclosed technology capitalizes on changes in market demand by processing large amounts of data that reflect real-time or near real-time market conditions. Capitalizing on real-time or near real-time market conditions can allow for the retail network to adapt to the changes in market demand to optimize net income throughout the reverse network. The disclosed technology can also be used to identify and determine which items may be more valuable to the retail network by sending those items to secondary liquidation markets versus selling the items at discounted prices in stores within the retail network.

The details of one or more implementations are set forth in the accompanying drawings and the description below. Other features and advantages will be apparent from the description and drawings, and from the claims.

### BRIEF DESCRIPTION OF THE DRAWINGS

FIG. 1A is a conceptual diagram for automatically categorizing and sorting reverse items for resale in a retail network.

FIG. 1B is a block diagram of a system for automatically categorizing and sorting reverse items for resale in a retail network.

FIG. 2 is a flowchart of a process for automatically categorizing and sorting reverse items for resale in a retail network.

FIG. 3 is a flowchart of a process for categorizing reverse items into low value and high value item categories.

FIG. 4 is a flowchart of a process for sorting high value items into multiple sub-category sorts.

FIG. 5 is an example table of sub-category sorts used for sorting high value items.

FIG. 6 is a system diagram of components used for performing the disclosed techniques.

FIG. 7 is a block diagram of computing devices that may be used to implement the systems and methods described in this document, as either a client or as a server or plurality of servers.

### DETAILED DESCRIPTION OF ILLUSTRATIVE EMBODIMENTS

The document generally describes techniques for categorizing reverse items for resale and delivering the categorized items through a variety of different reverse supply chains in a way to increase a net recovery rate for a retail network. The reverse items can include items that customers return to retail stores in the retail network. The reverse items can additionally or alternatively include overstock inventory in the retail store(s). In addition or alternatively, the revers items can include floor damages, or other items that are not suitable for sale through retail channels. Categorizing and delivering the reverse items can involve a two-step process in which the reverse items can be sorted into different reverse supply channels. Machine learning techniques and other rules and/or algorithms can be used to automatically categorize each reverse item as either high value or low value. For example, machine learning can be used to process sales data and other relevant data and optimize channel recommendations, with a purpose of maximizing profit for the retail network. High value items can further be sorted into one or more multiple sub-category sorts to determine resale channels for which to transport the high value items. Separating out high value items from low value items can allow for leveraging both salvage vendors to take pallets of low value items for liquidation and high return channels (e.g., D2C and B2B channels) to resell manifested pallets of high value items. Such determinations can be made using the disclosed techniques in order to optimize net income of the retail network.

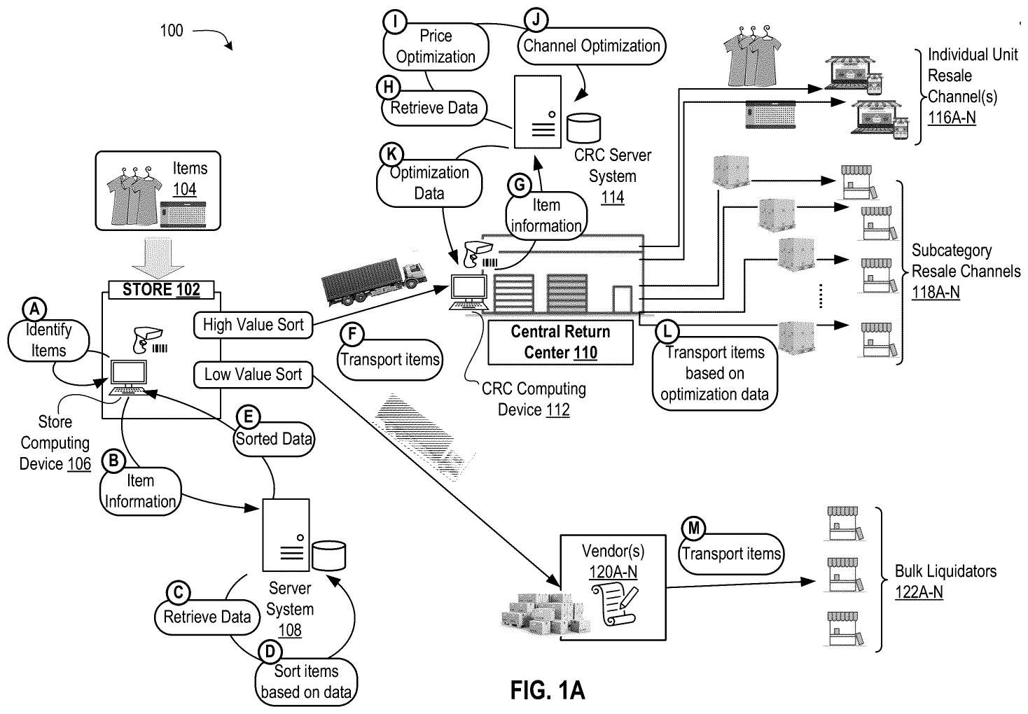

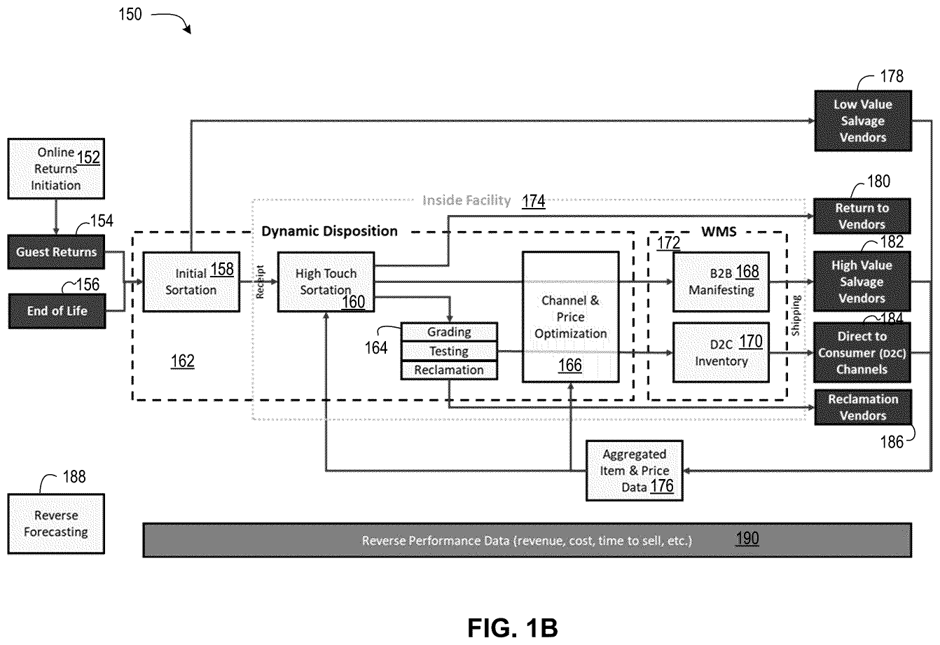

Referring to the figures, FIG. 1A is a conceptual diagram for automatically categorizing and sorting reverse items for resale in a retail network 100. At a high level, reverse items can be categorized, sorted, and then assigned to particular resale channels that can provide a greatest net income (e.g., gross income less expenses) for the retail network 100. In some implementations, machine learning and/or artificial intelligence (AI) techniques can be used in combination with data about the retail network 100 in order to calculate potential gross income for one or more particular resale channels. For example, the calculated potential gross income can then be used and applied on a category or class of items. In addition or alternatively, the calculated potential gross income can be used and applied on an individual item level rather than a category or class level for items. For example, a cost to ship to a D2C can be calculated for a particular item instead of determining an average cost for shipping items to the particular D2C.

The retail network 100 can include a variety of entities, including but not limited to stores 102, central return centers 110, vendors 120A-N, resale channels 116A-N and 118A-N, and/or bulk liquidators 122A-N.

The store 102 can be a physical retail environment. In some implementations, the store 102 can be an online retail environment that is part of the retail network 100. Items (e.g., products, goods) can be sold and purchased at the store 102. Some items 104 may also be returned at the store 102. These items 104 are also known as reverse items described throughout this disclosure. Customers can, for example, return the items 104. Although FIG. 1A is described in reference to customers returning the items 104, the items 104 can also include overstock inventory items or other suitable items in the store 102.

Referring to the example of FIG. 1A, when the items 104 are returned in the store 102, the items 104 can be scanned using one or more store computing devices 106. The store computing device 106 can be any type of computing device described herein, including but not limited to handheld scanners, other types of scanning devices, RFID readers, tablets, computers, mobile computing devices, computing devices of employees in the store 102, and/or computing devices of the customers returning the items 104.

Once the items 104 are scanned, they can be identified by the store computing device 106 (block A). For example, a barcode, label, or other unique identifier of the items 104 can be scanned by a scanning device. The scanned barcode can be processed by the store computing device 106 (e.g., using optical character recognition (OCR) techniques, object detection techniques, image analysis techniques) to determine an identity of the items 104 or other identifying information about the items. The determined information about the items 104 can then be transmitted to a server system 108 in communication over a network (e.g., wired and/or wireless) with the store computing device 106 for additional processing (block B).

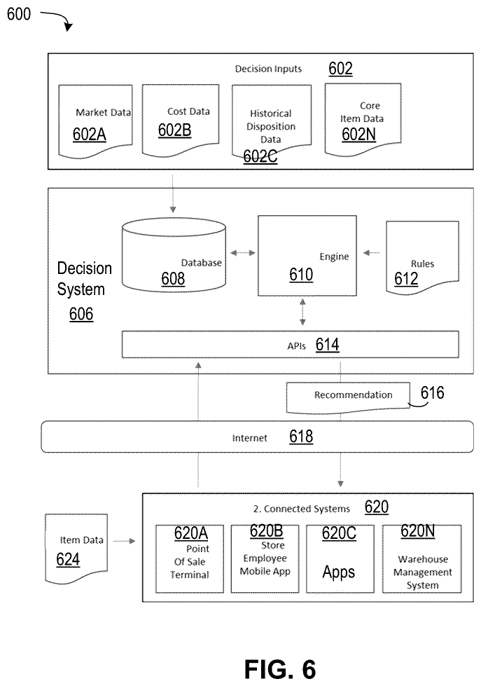

The server system 108 can be any computing system, network of computing devices, and/or cloud-based system configured to determine a sortation of the items 104. In other words, the server system 108 can perform the techniques described herein to determine whether each of the items 104 being returned should be categorized as high value or low value items for purposes of optimizing net income of the retail network 100 when disposing the items 104. In some implementation, the server system 108 is combined with a customer return center (CRC) server system 114 so as to perform a sortation of high value items into multiple sub-categories for resale through different channels suitable for optimizing the net income. As shown, the server system 108 can be remote from the store 102 and can perform the sortation techniques described herein for items returned to multiple stores in the retail network 100. In some implementations, the server system 108 can perform the sortation techniques for a particular store. In some implementations, the server system 108 can be part of the store computing device 106 of the store 102. The server system 108 is similar to or the same as, or implement, a decision system 606, which is described further in reference to FIG. 6.

In FIG. 1A, the server system 108 can retrieve item data for the items 104 based on the determined information that was received in block B (block C). The item data can be retrieved from a database, data store, data repository, and/or cloud-based storage system. The retrieved item data can include, but is not limited to, market data, cost data, historical disposition data, and/or core item data. Refer to FIG. 6 for further discussion about the type of data retrieved in block C.

The server system 108 can use the retrieved data to sort the items 104 (block D). In some implementations, the server system 108 can, for example, provide one or more of the retrieved data as input to a machine learning model that was trained to categorize items as high value or low value based on a combination of one or more of the retrieved data. In alternative implementations, the server system 108 can apply one or more rules to the retrieved data to determine whether the items 104 should be sorted/categorized as high value or low value items.

Once the sortation process is complete in block D, the server system 108 can transmit sorted data back to the store computing device 106 in block E. The sorted data can indicate, for example, whether each of the items 104 has been classified as a high value item or a low value item. The store computing device 106 can generate instructions for bucketizing the items 104 into their classified categories. For example, after the returns are processed for the items 104, an employee in the store 102 can separate items 104 categorized as high value into one group and items 104 categorized as low value into another group.

The high value items can be transported to the central return center (CRC) 110 (block F). The low value items can be transported to the vendors 120A-N (block F). At the central return center 110, a CRC computing device 112 can be configured to process and/or receive information/data about the high value items (block G). For example, the CRC computing device 112 can receive one or more of the item information determined in block A and/or the retrieved data in block C from the store computing device 106 and/or the server system 108. The CRC computing device 112 can also be similar to the store computing device 106 and can be configured to scan the high value items to identify the high value items. The CRC computing device 112 can then retrieve, from the database described herein, additional information about the identified high value items.

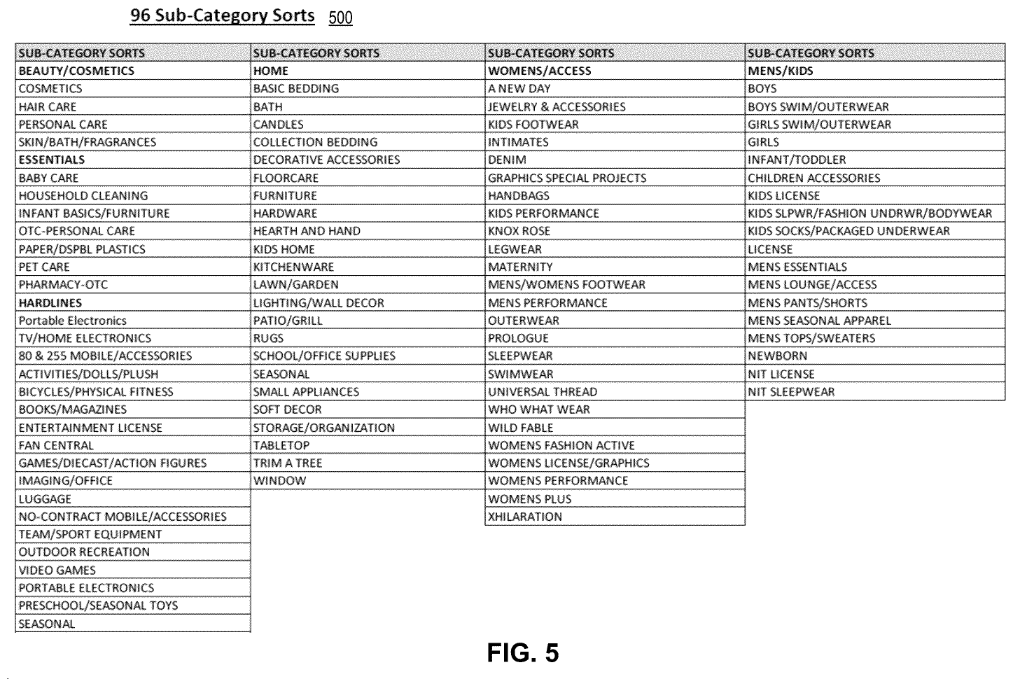

The CRC computing device 112 can transmit the item information/data to a CRC server system 114 (block G). The CRC server system 114 can be similar to and/or the same as the server system 108. In some implementations, the CRC server system 114 and the server system 108 can be configured as a combined system. In some implementations, the CRC server system 114 can be part of the CRC computing device 112. The CRC server system 114 can be part of (e.g., an engine or component of) the server system 108. The CRC server system 114 can retrieve data in block H based on the received item information. The data can be similar to and/or the same as the data retrieved in block C. The CRC server system 114 can also retrieve historic data about the retail network 100, a reverse network for the retail network 100, pricing data, and/or channel data, as described herein. Using the retrieved data, the CRC server system 114 can perform a second, more granular sortation process to sort the high value items into one or more sub-categories. The second, more granular sortation process can be performed based on one or more factors, including but not limited to item condition, market value, and/or particular channel expense/cost(s). Refer to FIG. 5 for further discussion about multiple different sub-categories for which the high value items can be sorted.

As part of the second sortation process, the CRC server system 114 can perform a price optimization process (block I). For example, the CRC server system 114 can apply one or more rules and/or machine learning models to the retrieved data to determine pricing of the high value items that may result in optimizing net income for the retail network 100. The pricing of each item can be determined with respect to a corresponding, suitable resale channel or each of the available resale channels. As part of the second sortation process, the CRC server system 114 can perform a channel optimization process (block J). For example, the CRC server system 114 can apply one or more rules and/or machine learning models to the retrieved data (and/or output of the price optimization process in block I) to determine which resale channels 116A-N and/or 118A-N are desired or preferred for reselling the high value items to increase or maximize net profit for the retail network 100. During the channel optimization process, the CRC server system 114 can assign the high value items to one or more particular resale channels 116A-N and/or 118A-N. For example, the high value items can be assigned to resale channels 116A-N as individual units for resale. In other words, a high value item can be identified as most profitable if resold in a retail environment, such as eBay, as an individual unit. Therefore, this high value item can be sorted for resale at a resale channel 116A-N intended for individual unit resale. This high value item can be sold via, for example, online D2C marketplaces. The CRC server system 114 can also assign the high value items to one or more resale channels 118A-N as subcategory resale items. Sometimes, a high value item can be more profitable if sold in some form of bulk as part of a sub-category of items. Accordingly, this high value item can be sorted for resale at a resale channel 118A-N intended for subcategory resale. This high value item can then be sold, for example, via auction and/or contracted rates at the resale channels 118A-N.

Once price and channel optimization has been determined in blocks I and J, the CRC server system 114 can transmit optimization data for the high value items to the CRC computing device 112 (block K). The CRC computing device 112 can then use the optimization data to generate instructions that cause the high value items to be sorted for transport to their designated resale channels 116A-N and/or 118A-N. For example, an employee or other user in the central return center 110 can receive instructions, at their computing device, from the CRC computing device 112 to group some of the high value items for transport to the resale channels 116A-N and others of the high value items for transport to the resale channels 118A-N. In addition or alternatively, the CRC 110 is fully or partially automated to sort the high value items based on the optimization data and convey the sorted items for transportation to respective resale channels. Accordingly, the high value items can then be transported, based on the optimization data, to their respectively assigned resale channels 116A-N and 118A-N (block L).

In some implementations, as described above, high value items can be sorted more granularly to sell in D2C and/or B2B channels. Given a broad range of some item types within a particular category level sort, some customers may only be interested in a subset of high value items included in the sort that the customers are purchasing. Therefore, by segmenting some category level sorts into multiple sub-category level sorts, customers can purchase only the specific item types they target, thereby maximizing gross income for the retail network 100. As an illustrative example, a single Home category can have many sub-category level sorts, such as furniture, bath bedding, kitchen, appliances, etc. By sorting high value items categorized as Home into the multiple sub-category level sorts, customers can more easily find and purchase particular items of interest.

Referring back to the block F, as previously mentioned, low value-sorted items can be transported to the vendors 120A-N. The low value-sorted items can be transported in bulk to the vendors 120A-N. The low value-sorted items can be directed to mixed, un-manifested lots or pallets. In other words, the low value items can be sold in un-sorted and/or un-manifested bulk quantities that can provide for flow of 100% of low value items (e.g., salvage items) directly to the vendors 120A-N, thereby bypassing the central return center 110. Disposing of low value items in this way can be beneficial to leverage bulk liquidation selling channels, thereby offering lowest recovery within a secondary market and generating significant gross income for the retail network 100. The vendors 120A-N can determine how to liquidate the low value items, such as at contracted rates. The vendors 120A-N can also determine which bulk liquidators 122A-N to assign the low value items. Accordingly, the low value items can then be transported to the assigned bulk liquidators 122A-N in block M. The bulk liquidators 122A-N can resell the low value items in bargain discount stores.

FIG. 1B is a block diagram of a system 150 for automatically categorizing and sorting reverse items for resale in a retail network. The techniques described in reference to FIG. 1B are the same as or similar to the techniques described above in reference to FIG. 1A. As shown, an item return can be initiated in block 152. The return can be initiated in a physical retail store and/or the return can be initiated in an online marketplace associated with the retail network. The item return initiation in block 152 can be identified as guest returns 154 or end of life 156 (e.g., overstock inventory, back of store operations). Next, the returned item(s) can undergo an initial sortation process 158, which can be performed by a dynamic disposition engine 162.

The dynamic disposition engine 162 can be a routing engine that makes decisions at various points within the retail network (e.g., in-stores, online, call center, in distribution center) based upon projected profitability per item. The engine 162 can incorporate various inputs/signals, such as third party new/open box marketplace pricing, historical trends, seasonality, sell-through, and supply chain costs, to make such decisions.

The initial sortation process 158 can include sorting the item as either high value or low value. This sort can be determined based on a variety of factors as described throughout this disclosure. When an item is categorized as low value, information can be generated by the computing systems described herein that causes the low value item to be transported to one or more low value salvage vendors 178.

An item that is categorized as high value can undergo a high touch sortation process 160 inside a facility 174, such as the central return center 110 described in FIG. 1A. Aggregated item and/or price data 176 associated with the high value item can also be processed with reverse logistics processing 164 that includes grading, testing, and reclamation of the item. Such processing 164 may also include receiving and reconciliation, item-level serialization, refurbishment/repair, inspection/grading, and dynamically optimizing disposition of the high value item into either a return to vendor(s) 180, high value salvage vendors 182, bulk business-to-business (B2B) return channel(s), direct-to-consumer (D2C) return channels 184, reclamation vendor(s) 186, and/or other future channels in the retail network.

A channel and price optimization engine 166 can be configured to receive item data (e.g., the data 176) from the high touch sortation process 160 and determine what resale channel to transport the returned item to in order to optimize net income of the retail network. The engine 166 can integrate various disposition channels, including primary and secondary marketplace e-commerce channels, partner D2C and B2B re-commerce channels, and other offline wholesale liquidation channels that may be part of the retail network. The engine 166 can also provide for automating merchandising and optimizing prices of items across all channels.

The item data from the high touch sortation process 160 can also be transmitted to the B2B manifesting engine 168 and/or D2C inventory engine 170 of a warehouse management system 172 (WMS). The engine 168 can provide techniques for building and manifesting pallets of specific item types, managing inventory levels, and preparing shipments to B2B re-commerce channels. The engine 168 can receive information from the high touch sortation process 160 indicating which returned items should be transported/shipped to which high value salvage vendors 182 (e.g., B2B re-commerce channels). The engine 168 can use this information to generate instructions that route the returned items to the correct resale channel(s). The engine 170 can manage inventory when each item is unique, then ship such items as demand comes into the retail network, either from D2C channels or by re-injecting the items back into the forward retail network. The engine 170 can receive information from the high touch sortation process 160 indicating which items should be transported/shipped to which D2C channels 186. Using this information, the engine 170 can generate instructions that route the items to the correct resale channel(s).

A reverse performance data system 190 can also be part of the system 150 to provide visibility of returned inventory outcomes and feedback on an on-going basis to help the disclosed computing systems, engines, and/or processes make improved future vendor, guest-keep, and/or other business decisions. Real-time reporting, dashboard tools, and data export to various reporting platforms can also be generated and provided by the system 190 to provide comprehensive visibility of a reverse supply chain, which can include physical retail stores, in-person item return initiation, and online return initiation to outbound distribution throughout the reverse network of the retail network.

Moreover, the system 150 can include a reserve forecasting engine 188, which can be configured to forecast a number of units (e.g., dollar amounts) flowing into and/or out of the reverse network of the retail network across various time horizons. Decision outcomes of the engine 188 can be used by any of the described engines (e.g., the initial sortation process 158, the high touch sortation process 160, the channel and price optimization engine 166) to generate informed decisions about how to categorize, sort, and/or transport reverse items in the retail network.

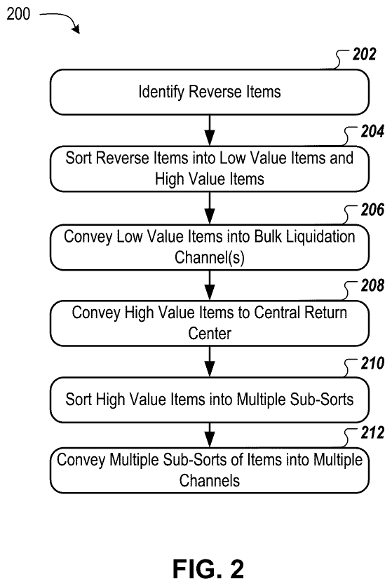

FIG. 2 is a flowchart of a process 200 for automatically categorizing and sorting reverse items for resale in a retail network. The process 200 can be performed by components described herein, or any combination thereof, such as the store computing device 106, the server system 108, the CRC computing device 112, and/or the CRC server system 114 described in FIG. 1A. One or more blocks in the process 200 can also be performed by the system components described in reference to FIG. 6. The process 200 may also be similar to or the same as one or more blocks described in FIG. 1B. For illustrative purposes, the process 200 is described from the perspective of a computing system.

Referring to the process 200 in FIG. 2, the computing system can identify reverse items in block 202. The reverse items can, in some implementations, be identified by a first computing system. The first computing device can include one or more barcode scanners, handheld scanning devices, RFID readers, imaging devices, or other types of scanning devices that can be used and/or available in a retail environment, such as a physical store. The reverse items can be identified by scanning identifiers provided at the reverse items. In other words, labels, barcodes, or other unique identifiers attached to items to be returned can be scanned by a scanning device in the physical store and then processed to identify each of the items as reverse items. In some implementations, the reverse items can be identified once a customer initiates a return of such items using an online service or mobile application presented at their mobile computing device. In some implementations, the items can be identified as reverse items when an employee in the physical store identifies the items as overstock inventory then scans the items using their respective computing device.

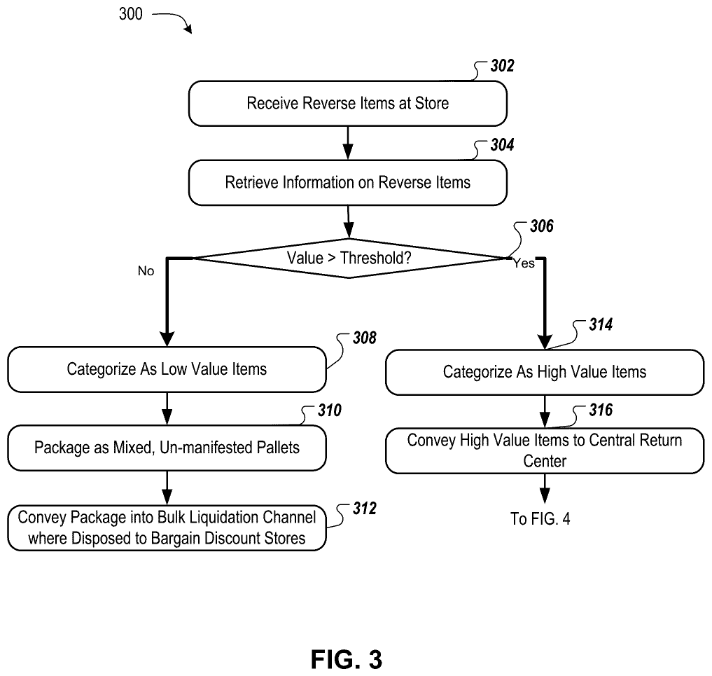

In block 204, the computing system can sort the reverse items into low value items and high value items. For example, the computing system retrieve information from a database about each of the identified reverse items. The computing system can process the retrieved information using one or more rules and/or machine learning algorithms to determine whether each of the reverse items should be categorized as a high value item or a low value item. As described herein, high value items can be resold or otherwise distributed in a reverse network of a retail network in such a way that optimizes or otherwise maximizes net income of the retail network. Low value items, on the other hand, may not be as profitable if resold or distributed in the reverse network as high value items. Therefore, the low value items can be handled differently than the high value items. Refer to the process 300 in FIG. 3 for further discussion.

The computing system can generate and return instructions to convey the low value items into one or more bulk liquidation channels in block 206. The low value items can be delivered, using a transportation system, to at least one resale channel that liquidates the low value items as a bulk. Liquidating the low value items in bulk can be more beneficial to maximize net income of the retail network than trying to resell or distribute the low value items as individual units. High value items, on the other hand, may be resold or distributed as individual units or a relatively small group of item if it is determined, by the computing system, that doing so would maximize or otherwise optimize the net income of the retail network.

The computing system can generate and return instructions to convey the high value items to one or more central return centers in block 208. Blocks 206 and 208 can be performed at a same time. Sometimes, block 208 can be performed before block 206. Accordingly, the high value items can be delivered, using the same or a different transportation system as the low value items, to a central return center or resale warehouse that resells or otherwise distributes the high value items.

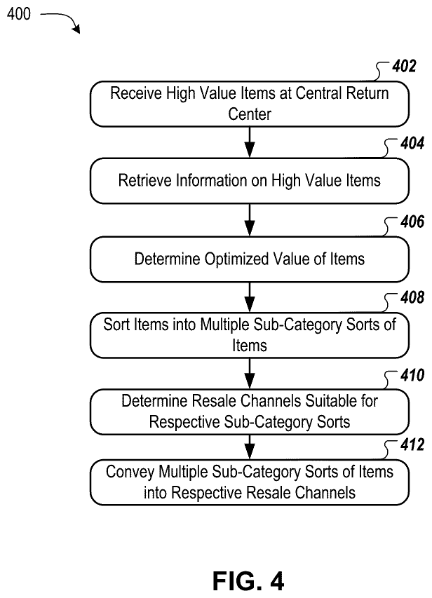

The computing system can further sort the high value items into multiple sub-sorts in block 210. This can be a second, more granular sortation process performed at the central return center. For example, the high value items can be categorized into one or more sub-sorts, of which one or more resale channels can then be determined for the categorized sub-sorts of the high value items. Refer to the process 400 in FIG. 4 and the table 500 in FIG. 5 for further discussion.

Accordingly, the computing system can generate and return instructions to convey the multiple sub-sorts of items into multiple channels in block 212. The multiple sub-sorts of items can be delivered, using the same or a different transportation system than the transportation system described above, to the one or more resale channels to then be resold and/or distributed in such a manner that maximizes or optimizes net income of the retail network.

Optionally, in some implementations, the computing system can process payment from the bulk liquidation channel(s) of block 206 and/or the multiple channel(s) of block 212. For example, the computing system can process payment from the bulk liquidation channel(s), where the payment is determined at a rate contracted with the respective bulk liquidation channel(s). Sometimes, the payment can be processed by the first computing system described above in block 202. As another example, the computing system can process payment from at least one of the multiple channels, where the payment is determined based on a price paid or payable by a buyer at the respective at least one of the multiple channels. Sometimes, the payment from the at least one of the multiple channels can be processed by a second computing system. The second computing system can be associated with the central return center or resale warehouse described herein.

FIG. 3 is a flowchart of a process 300 for categorizing reverse items into low value and high value item categories. The process 300 can be performed by components described herein, or any combination thereof, such as the store computing device 106 and/or the server system 108 described in FIG. 1A. One or more blocks in the process 300 can also be performed by the system components described in reference to FIG. 6. The process 300 may also be similar to or the same as one or more blocks described in FIG. 1B. For illustrative purposes, the process 300 is described from the perspective of a computing system.

Referring to the process 300 in FIG. 3, reverse items can be received at a physical store in block 302. Refer to block 202 in FIG. 2 for further discussion.

Information on the reverse items can be retrieved, by the computing system, in block 304. For example, the computing system can access a database storing reverse item data. The computing system can then retrieve, based on identifiers of the received reverse items, first values of the reverse items from the database. The first values of the reverse items can be determined based on resale costs and/or resale expenses of the reverse items. For example, the first value of each reverse item can be a value of the item at a resale market less an expense incurred for resale through the market. The computing system can, in some implementations, be the first computing system described in reference to the process 200 in FIG. 2.

The computing system can determine whether value information for each of the reverse items exceeds a threshold value in block 306. The threshold value can, in some implementations, be determined such that a majority of the reverse items can be categorized as a first sort of reverse items (e.g., low value items). The majority of the reverse items can be at least 70% of the reverse items. The majority of the reverse items can also be one or more other percentage values, including but not limited to 51%, 55%, 60%, 75%, 80%, 85%, 90%, 92%, 95%, etc. The threshold value can also be a predetermined monetary value. The predetermined monetary value can be based on historic resale data associated with a retail network having the reverse items.

If the value of a reverse item does not exceed the threshold value, then the computing system can categorize the reverse item as a low value item in block 308. In other words, the computing system can identify, based on the retrieved first values being equal to or less than the threshold value, one or more of the reverse items as a first sort of reverse items.

The computing system may generate and return instructions to package the low value item (as well as other reverse items that have been categorized as low value) as part of mixed, un-manifested pallets (block 310). For example, the first sort of reverse items can be delivered, using a transportation system, to at least one first resale channel. The first resale channel can liquidate the first sort of reverse items as a bulk.

The computing system can then generate and return instructions to convey the packaged low value item(s) into one or more bulk liquidation channels in block 312. The packaged low value item(s) can then be disposed to one or more bargain discount stores.

Referring back to block 306, if the value of each reverse item exceeds the threshold value in block 306, then the reverse item can be categorized, by the computing system, as a high value item in block 314. In other words, the computing system can identify, based on the retrieved first values exceeding the threshold value, one or more of the reverse items as a second sort of reverse items.

The computing system can then proceed to generate and return instructions to convey the high value item (along with other reverse items that have been categorized as high value) to a central return center or resale warehouse, as described throughout this disclosure (block 316). The process 400 described in FIG. 4 can then be performed. For example, the second sort of reverse items can be delivered to the resale warehouse. At the resale warehouse, the second sort of reverse items can be categorized into one or more sub-sorts of reverse items. One or more second resale channels can be determined for the one or more sub-sorts of reverse items. The one or more sub-sorts of reverse items can then be transported, using the same or different transportation system described above, into the one or more second resale channels, respectively.

In some implementations blocks 308 and 314 can be performed at a same or similar time. In some implementations, blocks 312 and 316 can be performed at a same or similar time.

FIG. 4 is a flowchart of a process 400 for sorting high value items into multiple sub-category sorts. The process 400 can be performed by components described herein, or any combination thereof, such as the CRC computing device 112 and/or the CRC server system 114 described in FIG. 1A. One or more blocks in the process 400 can also be performed by the system components described in reference to FIG. 6. The process 400 may also be similar to or the same as one or more blocks described in FIG. 1B. For illustrative purposes, the process 400 is described from the perspective of a computing system.

Referring to the process 400 in FIG. 4, high value items can be received at a central return center, such as a resale warehouse described herein (block 402). Refer to block 208 in the process 200 of FIG. 2 and block 316 in the process 300 of FIG. 3. For example, the computing device can identify the second sort of reverse items described in the process 300 of FIG. 3 by scanning identifiers provided at the second sort of reverse items. In some implementations, the computing system can be a second computing system associated with the resale warehouse.

The computing system can retrieve information on the high value items in block 404. The computing system can access a database storing reverse item data and available resale channels. The computing system can then retrieve, based on the identifiers of the second sort of reverse items, second values of the second sort of reverse items from the database. The second values of the second sort of reverse items can be determined based on a combination of data. The combination of data may include, but is not limited to, resale costs, resale expenses, and/or conditions of the second sort of reverse items. A first sort, as described above, can be performed in a store or other retail environment while the second sort can be performed in a return center. Although the first and second sorts may leverage the same underlying data, having the sorts performed at different times/locations can allow for optimizing expenses and driving efficiencies within the store and the return center in the retail network.

In some implementations, the database can be the same as the database described in reference to FIGS. 2 and/or 3. In some implementations, the database can be a second database that is different than the database described in reference to FIGS. 2 and/or 3.

Using the retrieved information, the computing system can determine an optimized value for each of the high value items (block 406). The optimized value can, in some implementations, be a price for reselling the high value item less an expense incurred for resale via a resale market or channel, which can result in optimizing or otherwise maximizing net income for a retail environment having the high value items. The optimized value can reflect the condition of the reverse item, which may affect the resale price through a relevant market or channel.

The computing system can sort the high value items into multiple sub-category sorts of items in block 408. For example, the computing system can determine, based on for example the attributes of the items (e.g., item type), the second sort of reverse items as one or more sub-sorts of reverse items. Further, the retrieved second values described above can be used to determine the second sort of reverse items as one or more sub-sorts of reverse items. The one or more sub-sorts of reverse items can include at least one first sub-sort of reverse items that can be resold as individual items through at least one of one or more second resale channels. The one or more sub-sorts of reverse items may also include at least one second sub-sort of reverse items. Each second sub-sort of reverse items can be sold as a whole through at least one of the one or more second resale channels. Refer to FIG. 5 for further discussion.

In block 410, the computing system can determine one or more resale channels suitable for each of the respective sub-category sorts of items. In other words, the computing system can determine, based on the available resale channels, the one or more of the second resale channels for the one or more sub-sorts of reverse items.

In some implementations, determining the second sort of reverse items as the one or more sub-sorts of reverse items and further determining the one or more second resale channels for the one or more sub-sorts of reverse items can include: calculating, by the computing system and based on the identifiers of the second sort of reverse items, the second values of the second sort of reverse items from the database with respect to each of at least one of the available resale channels, categorizing, using the computing system and based on the calculated values, the second sort of reverse items into the one or more sub-sorts of reverse items, and determining, using the computing system and based on the available resale channels, the one or more second resale channels for the one or more sub-sorts of reverse items, each of the one or more second resale channels being determined to provide a profit for a corresponding one of the one or more sub-sorts of reverse items. The profit can be greater than a profit offered by other available resale channels for the corresponding one of the one or more sub-sorts of reverse items.

The computing system can then generate and return instructions to convey the multiple sub-category sorts of items to the determined, respective resale channels (block 412). Using a transportation system, the one or more sub-sorts of reverse items can be delivered to the one or more second resale channels, respectively. The one or more sub-sorts of reverse items can be resold independently through the one or more second resale channels.

FIG. 5 is an example table 500 of sub-category sorts used for sorting high value items. As described in reference to the process 400 in FIG. 4, each of the high value reverse items can be sorted a second time into one or more of multiple sub-sorts of reverse items. The table 500 indicates some example sub-category sorts for which the high value items can be sorted. The sub-category sorts can include various categories in beauty/cosmetics, essentials, hardlines, home, womens/access, and mens/kids. One or more other sub-category sorts may also be identified for a particular retail network and used for sorting the high value items of that retail network. Additional or fewer sub-category sorts may also be identified for the particular retail network or a group of retail networks and then used for sorting the high value items of that retail network.

In some implementations, the sub-category sorts can be updated over time based on a feedback from the results of resale of reverse items. The sub-category sorts can be modified in a way to optimize or maximize the resale profit of reverse items coming in at stores. The sub-category sorts can vary depending on the types, volumes, weights, and/or other attributes of the reverse items available.

FIG. 6 is a system diagram of components used for performing the disclosed techniques. As shown in system 600, item data 624 can be received from one or more connected systems 620. The item data 624 can be received whenever an item is scanned or otherwise identified as being returned by a customer or part of overstock inventory, as described above. The item data 624 can include, but is not limited to, an Item Identifier (TCIN, UPC, etc.) as well as attributes related to a condition of the item, presence of accessories or packaging, etc.

The connected systems 620A-N can include, but are not limited to, point-of-sale (POS) terminals in one or more physical retail stores (e.g., which can be used for processing in-store returns), store employee mobile applications presented at one or more computing devices of employees in the physical retail store(s) (e.g., which can be used for processing guest returns as well as for repricing items or selecting items for removal from the store), other applications (e.g., which can be used by customers to pre-process returns), and/or a warehouse management system (WMS) (e.g., which can handle movement of the items through the reverse network of the retail network). The connected systems 620A-N can be part of multiple points in a flow of a guest return or inventory removal, which can send requests to a decision system 606 to perform any of the decision processes described herein. Any of the connected systems 620A-N can transmit the item data 624 via a network 618, such as Internet, and APIs 614 to the decision system 606.

The decision system 606 can be configured to perform the techniques described herein, thereby surfacing intelligent disposition decisions for movement of items throughout a reverse supply chain of the retail network. The decision system 606 may include a database 608, a decision engine 610, and the APIs 614. The APIs 614 can include a set of services that provide interfacing for requesting and responding to any of the connected systems 620A-N needing disposition intelligence from the decision system 606.

The database 608 can store various decision inputs 602A-N, including but not limited to market data, cost data, historical disposition data, and/or core item data. One or more of these inputs 602A-N, in addition to the item data 624, can be provided as input to the decision engine 610. The decision inputs 602A-N can be continually ingested into the database 608 to serve as inputs for the decision engine 610. The market data can include channel-specific data related to potential revenue associated with a reverse item (an item to be returned, as represented by the item data 624). The market data can include sales revenue as well as other values such as recycled value of materials, or value of the reduced item as an input to new items. The cost data can include channel-specific data associated with cost of processing the item. The cost data can include transportation costs, labor costs, refurbishment, or fixed per unit costs related to vendor contracts or affiliate fees. The historical disposition data can include results from disposition of past items inclusive of actual costs and revenue as well as soft metrics such as time to sale and/or guest satisfaction. The historical disposition data can include closed loop metrics that allow the engine 610 to refine recommendations based on past outcomes. The core item data can include attributes about the item itself, such as base cost, dimensions, weight, color, size, etc.

The decision engine 610 can use one or more rules 612 to determine how to categorize and/or sort the item(s) represented by the item data 624. The engine 610 can be a core set of code that can process a request for an item, by one or more of the connected systems 620A-N, to evaluate input data 602A-N and the rules 612. The engine 610 can use machine learning techniques, predictive analytics, and/or artificial intelligence to continually optimize recommendations for categorizing and/or sorting the item(s) represented by the item data 624. The rules 612 can include a set of conditions that can be used to influence decisions or override decisions made by the engine 610. Examples of the rules 612 can include, but are not limited to, prioritization of a donation strategy for a particular category or multiple categories of items, environmental rules requiring special or unique disposal of items, etc.

For example, the decision engine 610 can determine whether the item(s) should be categorized as high value or low value. The decision engine 610 can also perform additional processing, such as using machine learning techniques, to determine whether to further sort the high value item(s) into one or more sub-category sorts. Moreover, the engine 610 can determine which resale channel(s) to transport the item(s) to optimize net income of the retail network. Decisions made by the engine 610 can be returned, via the APIs 614, as one or more recommendations 616. The recommendation(s) 616 can be transmitted, via the network 618, to one or more of the connected systems 620A-N. The recommendation 616 can, for example, be presented at the WMS 620N and used to route the item to a particular retail channel that is most likely to optimize the net income of the retail network.

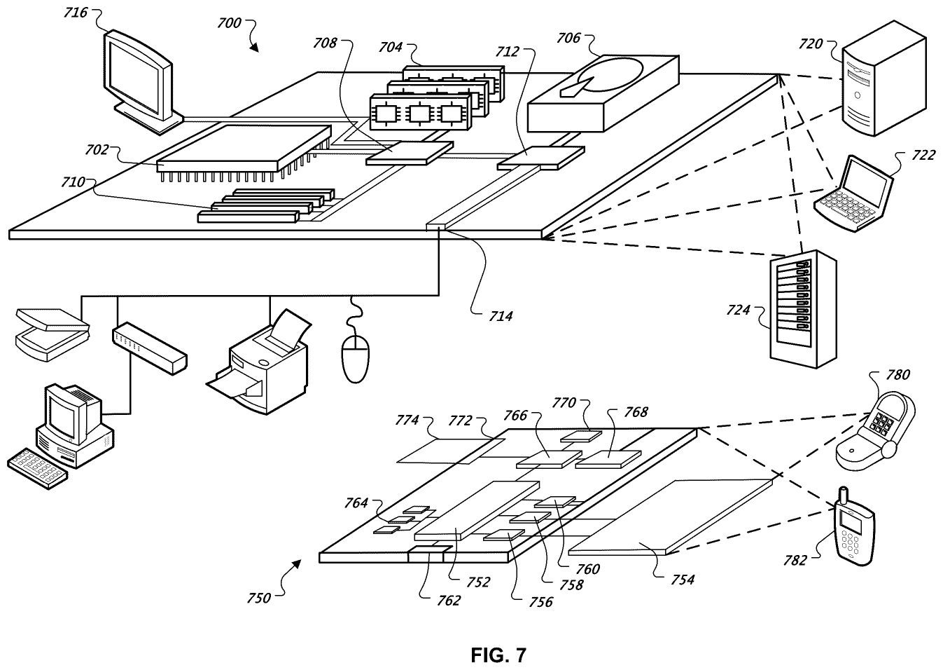

FIG. 7 is a block diagram of computing devices 700, 750 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be examples only, and are not meant to limit implementations described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high-speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high-speed controller 708 manages bandwidth-intensive operations for the computing device 700, while the low speed controller 712 manages lower bandwidth-intensive operations. Such allocation of functions is an example only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. Additionally, the processor may be implemented using any of a number of architectures. For example, the processor may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provided, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752 that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Additionally computing device 700 or 750 can include Universal Serial Bus (USB) flash drives. The USB flash drives may store operating systems and other applications. The USB flash drives can include input/output components, such as a wireless transmitter or USB connector that may be inserted into a USB port of another computing device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for reselling reverse items through multiple resale channels, the method comprising:
identifying, using a first computing system, a plurality of reverse items by scanning identifiers provided at the plurality of reverse items;
accessing, using the first computing system, a database storing reverse item data;
retrieving, using the first computing system and based on the identifiers of the plurality of reverse items, first values of the plurality of reverse items from the database;
identifying, using the first computing system and based on the retrieved first values being equal to or less than a threshold value, one or more of the plurality of reverse items as a first sort of reverse items;
identifying, using the first computing system and based on the retrieved first values exceeding the threshold value, one or more of the plurality of reverse items as a second sort of reverse items;
delivering, using a transportation system, the first sort of reverse items to at least one first resale channel, wherein the first resale channel liquidates the first sort of reverse items as a bulk; and
delivering, using the transportation system, the second sort of reverse items to a resale warehouse, wherein, at the resale warehouse, the second sort of reverse items are categorized into a plurality of sub-sorts of reverse items, and a plurality of second resale channels are determined for the plurality of sub-sorts of reverse items, the plurality of sub-sorts of reverse items being transported into the plurality of second resale channels, respectively.

2. The method of claim 1, wherein the first values of the plurality of reverse items are determined based on resale costs and resale expenses of the plurality of reverse items.

3. The method of claim 1, wherein the threshold value is determined such that a majority of the plurality of reverse items is categorized as the first sort of reverse items.

4. The method of claim 3, wherein the majority of the plurality of reverse items is at least 70% of the plurality of reverse items.

5. The method of claim 1, wherein the threshold value is a predetermined monetary value.

6. The method of claim 1, further comprising:
identifying, using a second computing system associated with the resale warehouse, the second sort of reverse items by scanning identifiers provided at the second sort of reverse items;
accessing, using the second computing system, a second database storing reverse item data and available resale channels;
retrieving, using the second computing system and based on the identifiers of the second sort of reverse items, second values of the second sort of reverse items from the second database;
determining, using the second computing system and based on the retrieved second values, the second sort of reverse items as the plurality of sub-sorts of reverse items;
determining, using the second computing system and based on the available resale channels, the plurality of second resale channels for the plurality of sub-sorts of reverse items; and
delivering, using the transportation system, the plurality of sub-sorts of reverse items to the plurality of second resale channels, respectively, wherein the plurality of sub-sorts of reverse items are resold independently through the plurality of second resale channels.

7. The method of claim 6, wherein the second values of the second sort of reverse items are determined based on resale costs, resale expenses, and conditions of the second sort of reverse items.

8. The method of claim 6, wherein determining (i) the second sort of reverse items as the plurality of sub-sorts of reverse items and (ii) the plurality of second resale channels for the plurality of sub-sorts of reverse items comprises:
calculating, using the second computing system and based on the identifiers of the second sort of reverse items, the second values of the second sort of reverse items from the second database with respect to each of at least one of the available resale channels;
categorizing, using the second computing system and based on the calculated values, the second sort of reverse items into the plurality of sub-sorts of reverse items; and
determining, using the second computing system and based on the available resale channels, the plurality of second resale channels for the plurality of sub-sorts of reverse items, each of the plurality of second resale channels being determined to provide a profit for a corresponding one of the plurality of sub-sorts of reverse items, the profit being greater than a profit offered by other available resale channels for the corresponding one of the plurality of sub-sorts of reverse items.

9. The method of claim 6, wherein the plurality of sub-sorts of reverse items includes at least one first sub-sort of reverse items that are resold as individual items through at least one of the plurality of second resale channels.

10. The method of claim 9, wherein the plurality of sub-sorts of reverse items includes at least one second sub-sort of reverse items, each second sub-sort of reverse items being sold as a whole through at least one of the plurality of second resale channels.

11. The method of claim 1, further comprising:
processing, using the first computing system, payment from the first resale channel, the payment being determined at a rate contacted with the first resale channel.

12. The method of claim 8, further comprising:
processing, using the second computing system, payment from the at least one of the plurality of second resale channels, the payment being determined based on a price paid or payable by a buyer at the at least one of the plurality of second resale channels.

13. The method of claim 1, wherein the first computing system includes one or more barcode scanners.

14. A computing system for reselling reverse items through multiple resale channels, the system comprising
a data processing apparatus; and
a memory device storing instructions that when executed by the data processing apparatus cause the server to perform operations comprising:
identifying, using a first computing system, a plurality of reverse items by scanning identifiers provided at the plurality of reverse items;
accessing, using the first computing system, a database storing reverse item data;
retrieving, using the first computing system and based on the identifiers of the plurality of reverse items, first values of the plurality of reverse items from the database;
identifying, using the first computing system and based on the retrieved first values being equal to or less than a threshold value, one or more of the plurality of reverse items as a first sort of reverse items;
identifying, using the first computing system and based on the retrieved first values exceeding the threshold value, one or more of the plurality of reverse items as a second sort of reverse items;
delivering, using a transportation system, the first sort of reverse items to at least one first resale channel, wherein the first resale channel liquidates the first sort of reverse items as a bulk; and
delivering, using the transportation system, the second sort of reverse items to a resale warehouse, wherein, at the resale warehouse, the second sort of reverse items are categorized into a plurality of sub-sorts of reverse items, and a plurality of second resale channels are determined for the plurality of sub-sorts of reverse items, the plurality of sub-sorts of reverse items being transported into the plurality of second resale channels, respectively.

15. The computing system of claim 14, wherein the first values of the plurality of reverse items are determined based on resale costs and resale expenses of the plurality of reverse items.

16. The computing system of claim 14, wherein the threshold value is determined such that a majority of the plurality of reverse items is categorized as the first sort of reverse items.

17. The computing system of claim 14, wherein the threshold value is a predetermined monetary value.

18. The computing system of claim 14, wherein the operations further comprises:
identifying, using a second computing system associated with the resale warehouse, the second sort of reverse items by scanning identifiers provided at the second sort of reverse items;
accessing, using the second computing system, a second database storing reverse item data and available resale channels;
retrieving, using the second computing system and based on the identifiers of the second sort of reverse items, second values of the second sort of reverse items from the second database;
determining, using the second computing system and based on the retrieved second values, the second sort of reverse items as the plurality of sub-sorts of reverse items;
determining, using the second computing system and based on the available resale channels, the plurality of second resale channels for the plurality of sub-sorts of reverse items; and
delivering, using the transportation system, the plurality of sub-sorts of reverse items to the plurality of second resale channels, respectively, wherein the plurality of sub-sorts of reverse items are resold independently through the plurality of second resale channels.

19. The computing system of claim 18, wherein determining (i) the second sort of reverse items as the plurality of sub-sorts of reverse items and (ii) the plurality of second resale channels for the plurality of sub-sorts of reverse items comprises:
calculating, using the second computing system and based on the identifiers of the second sort of reverse items, the second values of the second sort of reverse items from the second database with respect to each of at least one of the available resale channels;
categorizing, using the second computing system and based on the calculated values, the second sort of reverse items into the plurality of sub-sorts of reverse items; and
determining, using the second computing system and based on the available resale channels, the plurality of second resale channels for the plurality of sub-sorts of reverse items, each of the plurality of second resale channels being determined to provide a profit for a corresponding one of the plurality of sub-sorts of reverse items, the profit being greater than a profit offered by other available resale channels for the corresponding one of the plurality of sub-sorts of reverse items.

20. The computing system of claim 18, wherein the plurality of sub-sorts of reverse items includes at least one first sub-sort of reverse items that are resold as individual items through at least one of the plurality of second resale channels, and
wherein the plurality of sub-sorts of reverse items includes at least one second sub-sort of reverse items, each second sub-sort of reverse items being sold as a whole through at least one of the plurality of second resale channels.
